(19) United States
(12) Patent Application Publication
(10) Pub. No.: US 2023/0234153 A1
(43) Pub. Date: Jul. 27, 2023

(54) METHOD FOR DEFINING WELDING PARAMETERS FOR A WELDING PROCESS ON A WORKPIECE AND WELDING DEVICE FOR CARRYING OUT A WELDING PROCESS ON A WORKPIECE WITH DEFINED WELDING PARAMETERS

(71) Applicant: Fronius International GmbH, Pettenbach (AT)

(72) Inventor: Helmut ENNSBRUNNER, Pettenbach (AT)

(73) Assignee: Fronius International GmbH, Pettenbach (AT)

(21) Appl. No.: 17/926,722

(22) PCT Filed: Jan. 24, 2022
(86) PCT No.: PCT/EP2022/051480

§ 371 Date: Nov. 21, 2022

(30) Foreign Application Priority Data
Jan. 25, 2021 (EP) 21153236.1

(51) Int. Cl. B23K 9/02; B23K 9/095; B23K 9/235; B23K 9/32; B23K 31/02; B23K 37/00

(52) U.S. Cl. CPC B23K 9/02; B23K 9/0953; B23K 9/0956; B23K 9/235; B23K 9/32; B23K 31/02; B23K 37/003

(57) ABSTRACT

In a method for defining welding parameters for a welding process on a workpiece, a welding torch fastened to a robot is guided over the workpiece along a predetermined welding path and predetermined welding parameters for processing the workpiece are set as a function of the position along the welding path. A welding device carries out a welding process. For the more exact definition of the welding parameters, before the welding process is carried out, at least one parameter representing the cooling is recorded as a function of the position along the welding path, and the at least one parameter representing the cooling along the welding path is considered for the welding process when defining optimized welding parameters as a function of the position along the welding path.

The invention relates to a method for defining welding parameters for a welding process on a workpiece, in which a welding torch fastened to a robot is guided over the workpiece along a predefined welding path and, depending on the position along the welding path, predefined welding parameters for processing the workpiece are set.

Furthermore, the present invention relates to a welding device for carrying out a welding process on a workpiece with defined welding parameters, having a welding torch which is fastened to a robot and is guidable over the workpiece along a predetermined welding path during the welding process, the welding torch being connected to a welding current source, which welding current source has a control device for controlling the welding process with predefined welding parameters as a function of the position along the welding path.

The present invention relates mainly to automated, robot-assisted welding processes and welding devices in which the welding torch is automatically guided along a predetermined welding path over the workpiece or additively manufactures a workpiece (Wire-Arc Additive Manufacturing WAAM). Welding processes with fusible welding electrode (MIG/MAG welding process) as well as with non-fusible welding electrode (TIG welding process) are covered. Theoretically, an application is also conceivable in manual welding processes. Furthermore, the invention also relates to arc soldering, in which case, in contrast to welding, there is no substantial melting of the workpiece.

In arc welding processes, an additional material is usually melted to form a welded joint, the workpiece to be welded is melted and a weld seam is formed. The quality of the welded joint is highly dependent on the time course of the cooling process of the welded seam. This time course of the cooling process is dependent on the heat energy introduced, the temperature of the workpiece and of the clamping devices, as well as on the local geometry of the workpiece and of the clamping devices, the ambient temperature or workpiece base temperature, and the respective material properties (specific heat capacity and thermal conductivity). The geometry of the workpiece and the geometry and arrangement of the clamping devices around the weld seam in conjunction with the physical parameters of the various materials mainly influence and define the cooling process of a weld seam. In known welding methods, the geometry of the workpiece and the geometry and arrangement of the clamping devices are not taken into consideration at all, or only to a certain extent, in that test welding is carried out on test workpieces and the welding parameters are correspondingly adapted to the respective cooling situation. However, such methods are relatively time-consuming and require the knowledge of appropriate welding experts, are not reproducible and cannot be automated. Moreover, in the case of individual components, it is not possible to carry out test welding beforehand. Quantitatively, however, the cooling situation is not known.

Particularly in the case of thicker workpieces or very sensitive workpiece alloys, it is known to measure the workpiece temperature before the welding process, as a result of which the cooling rate of the weld seam, and thus the metallurgical properties, are indirectly monitored. If the workpiece temperature is not within a permissible range, the welding process must be delayed until the workpiece has fallen below the maximum permissible workpiece temperature or the workpiece is heated by means of heaters until the workpiece has exceeded the minimum required workpiece temperature. With these measures, it can be ensured that the quality of the welded joint is given in the presence of normal cooling. In the case of thin-walled workpieces or less sensitive workpiece alloys, measurement of the temperature of the workpiece is not customary and preheating of the workpiece is undesirable because of the high costs and the time required for this.

Furthermore, there are methods in which the temperature field on the cooling weld seam is observed in order to detect possible quality problems.

From WO 2018/011243 A1 a method for defining welding parameters for a welding process is known, wherein the welding parameters are automatically defined on the basis of ideal welding parameters previously recorded on test workpieces as a function of the current position and arrangement of the workpiece with respect to the gravitational acceleration vector and the current tangential vector of the welding path. Although it is mentioned that the cooling situation can be taken into consideration, no details are disclosed as to how the real cooling situation of the workpiece is to be taken into account in the automatic definition of welding parameters.

US 2015/0375325 A1 describes a method in which the temperature or a temperature change of the workpiece is detected before the welding operation and welding parameters are selected accordingly as a function of the measured temperature. By taking into consideration the current temperatures and a corresponding adaptation of the welding parameters, the heat to be introduced into the workpiece can be adapted to the current temperature and the exceeding of a maximum permissible temperature can be prevented.

WO 2013/113993 A1 describes a method of the present type, in which the welding parameters are adapted as a function of a desired cooling behaviour in order to achieve a specific welding quality or a desired metallurgical structure.

U.S. Pat. No. 4,817,020 A describes a laser machining process, for example a laser welding process, in which the cooling rate is determined during the machining process and the machining parameters are adapted thereto in real time.

The object of the present invention is to provide an above-mentioned method for defining welding parameters and a welding device for carrying out a welding process on a workpiece with defined welding parameters, the actual cooling situation on the real workpiece being taken into consideration in order to be able to improve the welding quality and reproducibility of the welding. The method and the device should be as simple and cost-effective as possible to implement and no expensive welding experts should have to be consulted or previous test welding should have to be carried out on test workpieces. Disadvantages of known methods and devices are to be avoided or at least reduced.

The object according to the invention is achieved in terms of the method by the fact that, before the welding process is carried out, at least one parameter representing the cooling is recorded depending on the position along the welding path, and the at least one parameter representing the cooling along the welding path is considered for the welding process during the definition of optimised welding parameters depending on the position along the welding path. Before the welding process, the cooling behaviour on the surface of the real workpiece along the welding path is detected, taking into consideration the geometry of the workpiece together with the clamping devices arranged thereon, and at least one suitable parameter, which represents the respective cooling situation in the form of a suitable description variable along the intended welding path, is determined therefrom and considered in the subsequent welding process. Before the welding process is carried out means before the welding process or also during the welding process but in the preparatory step of the welding process. The cooling situation is influenced, inter alia, by the material properties and dimensions (measurements) of the workpieces, by the seam geometry, by the gap between the workpieces to be joined, by the basic temperature of the workpieces, by the material properties, by the size and arrangement of the clamping devices and by the ambient temperature, which of course determines the basic temperature of the workpiece. The basic temperature of the workpiece is also influenced by a welding process and may have an influence on the subsequent welding processes if the workpiece has not yet cooled down before the subsequent welding process. In the case of additive welding methods (WAAM), the cooling behaviour of the last layer in the case of a layered construction of a workpiece can be used for determining the cooling for the welding of the next layer. When the at least one parameter representing the cooling is recorded, the real workpiece is not melted or is not substantially melted or the microstructure is changed. By means of the at least one newly determined parameter representing the cooling, the subsequent welding process can be correspondingly better controlled, and certain welding parameters, such as, for example, the welding power, the welding speed, or other welding or movement parameters, can be correspondingly adapted or optimised, as a result of which the welding quality can be increased and, in particular, a better reproducibility of the welding can be achieved. The higher outlay consists merely in taking up the at least one parameter representing the cooling before carrying out the welding process, which, however, can also be carried out substantially more quickly than the welding process and also on a virtual workpiece simulating the real workpiece by means of a simulation. By considering the real cooling situation in the determination of the optimised welding parameters for the welding process, a compensation of any interfering influence of the geometry of the workpiece or the geometry of a clamping device along the welding path, and thus a higher welding quality, is achieved. Thus, if it is determined that the actual cooling situation deviates from the normal cooling situation to an interfering extent, compensation or countermeasures are initiated. The simplest countermeasures in the event of a different cooling situation include an adaptation of the welding parameters. For example, an increase in the welding power can counteract locally stronger cooling. Alternatively, the distance between the welding torch and the workpiece, the angle of incidence, the welding speed, the relative positioning of the welding torch with respect to the workpiece, and other process parameters can be changed in order to obtain a weld with optimum quality (so-called IO or “In order” weld seam). The countermeasures can also include active, local workpiece heating or cooling, which could be used, for example, during a cleaning process before the welding process. A further countermeasure may, for example, also be the modification of the clamping devices, whereby the heat dissipation between the workpiece and the surroundings is modified. Especially in the automatic determination of optimised welding parameters from ideal welding parameters, which were previously discovered by experts on test workpieces, the consideration of the real cooling situation of the real workpiece is essential and advantageous. Preferably, at least two parameters representing the cooling are recorded along the welding path and considered in the determination of optimised welding parameters as a function of the position along the welding path, wherein a parameter representing the cooling is the basic temperature of the workpiece along the welding path.

According to one embodiment of the invention, before carrying out the welding process, the workpiece is heated along the welding path with a heat source, and the at least one parameter representing the cooling is recorded along the welding path with the aid of at least one detection device. With a suitable and well-defined heat source with a known power density distribution and a suitable detection device for determining the temperature at the surface of the workpiece along the welding path, a description variable for the local cooling along the welding path can thus be determined. From the knowledge of this cooling information, corrections of the welding parameters are derived during the welding process by considering this cooling information accordingly. The heat source can be formed, for example, by laser, TIG, plasma or gas torches and has a known power density distribution. The energy of the heat source introduced into the workpiece, the local distribution of the introduction of heat and the speed of movement are correspondingly matched to the performance of the subsequent welding process and the respective welding task. In this case, the distance energy used, i.e. the power factor divided by the speed of movement, is selected so that there is no melting of the workpiece, or only a slight melting, and there are no changes in the microstructure or the geometry of the workpiece, but on the other hand a sufficient temperature change results for the detection device used. If different heat sources or detection devices are used in test workpieces to find ideal welding parameters and on the real workpiece, then these must be calibrated in order to be able to guarantee comparability of the results.

For example, the workpiece can be heated in a pulse-like manner along the welding path, preferably to a temperature below the melting temperature of the workpiece, and the response to the heat pulse can be recorded with the aid of the at least one detection device, and parameters which represent the cooling behaviour of the workpiece along the welding path can be derived or calculated therefrom.

Alternatively or additionally, the workpiece can also be heated along the welding path with a light source, in particular a laser beam source, as the heat source. The intensity of the light source, in particular the laser beam source, is selected so that there is no interfering melting or structural change in the workpiece.

The at least one parameter representing the cooling along the welding path can be recorded contactless, for example with the aid of a thermal imaging camera, in particular an infrared camera, as a detection device. Just as in the case of the local distribution of the heat of the heat source, there is also a local temperature distribution with the region detected by the detection device. Ideally, the thermal imaging camera is used to record or measure the temperature distribution of all the workpieces and components involved, such as, for example, clamping devices, along and in an environment around the welding path. The local extent of the detection preferably corresponds to the size of the heat influencing zone or the extent of the workpiece or workpieces by the at least one heat source.

In addition, the at least one parameter representing the cooling along the welding path can be recorded with the aid of at least one temperature sensor as a detection device on the surface of the workpiece. This represents a simpler and more cost-effective solution than the use of a thermal imaging camera with, at the same time, simpler evaluation. For certain applications, however, detection with the aid of temperature sensors or an array of a plurality of temperature sensors may be sufficient.

According to a further feature of the invention, in addition to the recording, in particular during the recording, of the at least one parameter representing the cooling along the welding path, the basic temperature of the workpiece can also be recorded. As a result, the basic temperature of the workpiece can be taken into account when detecting the cooling behaviour of the workpiece. This can bring an advantage, for example, during welding at extreme ambient temperatures.

If the at least one parameter representing the cooling is recorded along the welding path during a cleaning process carried out before the welding process, in particular a surface plasma processing process, time can be saved since the recording of the parameter representing the cooling is recorded simultaneously with the cleaning process carried out anyway.

In addition to the methods described above, a virtual replication of the workpiece along a virtual welding path corresponding to the welding path can also be heated with a virtual heat source before the welding process is carried out, and the at least one parameter representing the cooling along the virtual welding path can be recorded, that is to say calculated or simulated, with the aid of at least one virtual detection device. The virtual replication can be carried out approximately via the definition of the cross section of the welding arrangement at a plurality of points of the welding path and can be approximated therebetween by interpolation. The determination of the cooling behaviour can thus be simulated on a virtual workpiece. For example, a user may use appropriate software or smartphone app to replicate the real workpiece including clamping devices and thereby define a cooling situation. On the basis of correspondingly stored solutions and calculations, the cooling behaviour can be simulated and corresponding parameters representing the cooling of the virtual workpiece can be recorded along the virtual welding path. If the determination of the cooling behaviour takes place in a simulation, the power or power distribution can be selected practically freely. In addition, non-linear effects in the temperature line in the workpiece can also be simulated in a realistic manner. In the simulation, problems which can arise in the case of a real measurement as a result of the movement of the heat source and of the detection device over the workpiece, and their influence, can be eliminated. In the simulation, the exact temperature can be determined at any point on the workpiece. The information about the thermal behaviour of different workpieces can be determined in practice with the aid of test workpieces. In the simulation, a model of the real welding process can be used as a virtual heat source and the observed cooling situation can be used with at least one parameter representing the cooling (preferably at least two parameters representing the cooling, one parameter being the workpiece basic temperature) in order to improve the model parameters until an ideal welding result is obtained.

Likewise, before carrying out the welding process, it is possible, from a virtual replication of the workpiece with predetermined environmental situations, for example clamping devices, to determine the at least one parameter representing the cooling along a virtual welding path corresponding to the welding path, from stored properties of the virtual replication of the workpiece as a function of the material and the geometric conditions. In this variant of a simulation, the at least one parameter representing the cooling can be determined without a virtual heat source from the material properties and geometric conditions of the workpiece and the clamping devices, since the current cooling situation is derived from known “building blocks” with known parameters representing the cooling. Such a method can be implemented, for example, with a program on a computer, the smartphone or a robot controller, and thus the cooling situation can also be simply estimated and taken into account by a not necessarily well trained welder.

The process of recording the at least one parameter representing the cooling along the welding path can be carried out at a speed which is higher than or equal to the welding speed during the welding process. If the speed is selected to be higher, the time for detecting the cooling behaviour of the workpiece can be reduced.

In this case, for example, the average cooling rate can be recorded as a parameter representing the cooling. The average cooling rate represents a parameter which can be detected and processed relatively easily. Other parameters can, for example, be obtained and derived from the recorded thermal imaging cameras by special image processing methods.

When exceeding and/or falling below predetermined threshold values for a parameter representing the cooling along the welding path, a warning can be issued and/or a message can be stored. As a result, reference can be made to points along the welding path at which the thermal management is particularly critical. The warning can be emitted to the person or position of interest in the form of acoustic, optical or mechanical information.

The object according to the invention is also achieved by a welding device of the present type, in which a recording device is provided for recording at least one parameter representing the cooling down as a function of the position along the welding path before the welding process is carried out, and the control device is connected to the recording device and is designed to control the welding process with optimised welding parameters as a function of the position along the welding path, considering the at least one parameter representing the cooling down along the welding path. Depending on the design of the recording device, such a welding device must be equipped accordingly. However, many components, such as, for example, cameras, temperature sensors and, of course, also corresponding control devices, are present in any case in many welding devices and need only be adapted or programmed for the use described. With regard to the further advantages which can be achieved by the welding device according to the invention, reference is made to the above description of the method according to the invention for establishing welding parameters for a welding process on a workpiece.

According to one feature of the invention, the recording device for recording the at least one parameter representing the cooling along the welding path contains a heat source for heating the workpiece along the welding path and at least one detection device for recording the at least one parameter representing the cooling along the welding path. With the heat source and detection device activated, the welding device is moved along the welding path prior to the welding process or during the welding process, as a preparatory step of the welding process, in order to be able to record at least one parameter representing the cooling, which parameter is correspondingly considered in the subsequent welding process.

The heat source for heating the workpiece along the welding path may be generated by a light source, in particular a laser beam source. This represents a simple and relatively easily realisable form of the heat source.

The heat source is preferably designed to heat the workpiece along the welding path to a temperature below the melting temperature of the workpiece and also below the temperature by which the structure of the workpiece is influenced.

At least one detection device may be formed, for example, by a thermal imaging camera, in particular an infrared camera.

Furthermore, at least one detection device can be formed by at least one temperature sensor for measuring the temperature of the surface of the workpiece along the welding path. The at least one temperature sensor can be used, on the one hand, for determining the cooling behaviour and, on the other hand, also for determining the workpiece temperature before the welding process. As already mentioned above, the temperature of the workpiece also influences the cooling behaviour.

If at least one temperature sensor is provided for measuring the basic workpiece temperature, this basic workpiece temperature can be taken into account when recording the at least one parameter representing the cooling along the welding path.

The recording device for recording the at least one parameter representing the cooling along the welding path can also contain a virtual heat source for heating a virtual replication of the workpiece along a virtual welding path corresponding to the welding path and at least one virtual detection device for recording the at least one parameter representing the cooling along the virtual welding path. In a virtual welding process, the virtual heat source can also be formed by the virtual welding process.

The present invention is further explained with reference to the appended drawings. In the drawings:

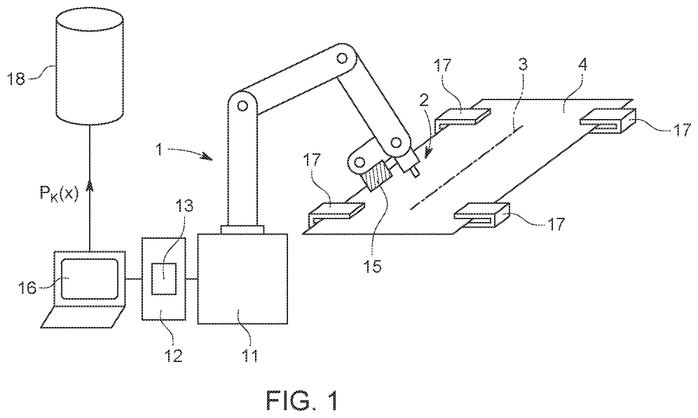

FIG. 1 is a schematic representation of a welding device configured to receive a parameter representing the cooling along the welding path of a workpiece prior to performing the welding process;

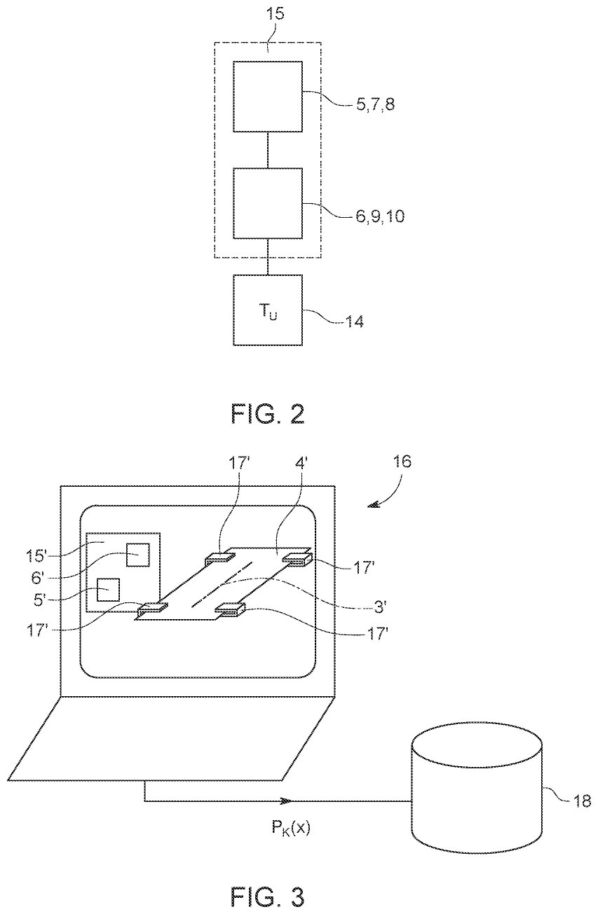

FIG. 2 is a block diagram of an embodiment of a recording device for recording a parameter representing the cooling along the welding path;

FIG. 3 is a schematic block diagram of a virtual recording device for recording at least one parameter representing the cooling along the virtual welding path of a virtual workpiece;

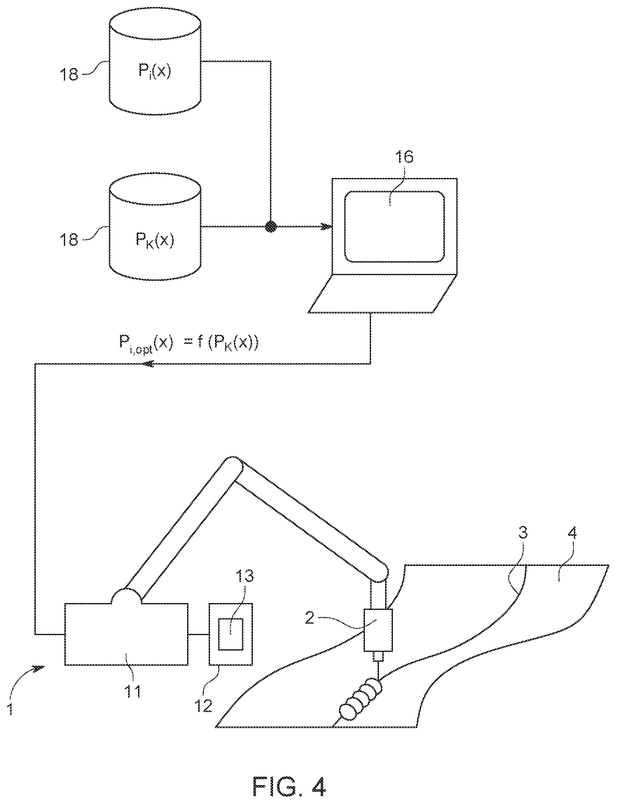

FIG. 4 is a schematic representation of a welding device during the execution of a welding process, taking into account at least one parameter representing the cooling recorded before the welding process in the determination of the welding parameters;

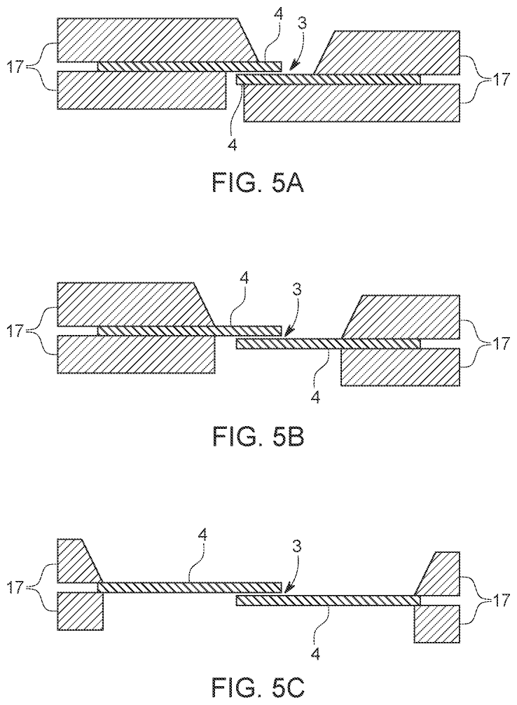

FIGS. 5A to 5C show various clamping situations of a workpiece to illustrate the resulting different cooling behaviour along the weld path;

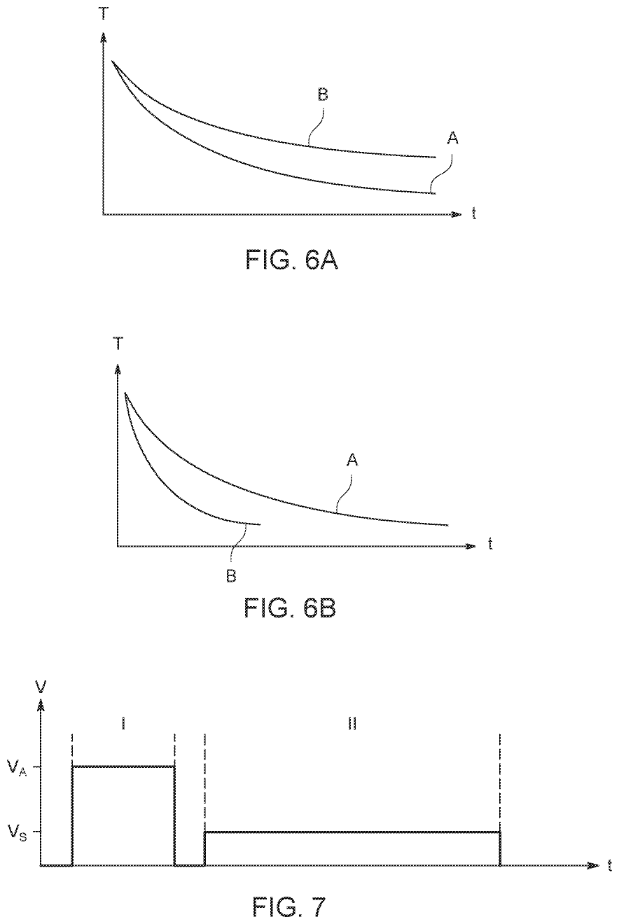

FIGS. 6A and 6B show two temporal cooling curves with different cooling behaviour and different temperature of the workpiece; and

FIG. 7 shows the course over time of a method carried out before the welding process for recording at least one parameter representing the cooling along the welding path of a workpiece and the subsequent welding process, considering the at least one parameter representing the cooling in the determination of the welding parameters.

FIG. 1 shows a schematic representation of a welding device 1 configured to record a parameter P_{K}(x) representing the cooling along the welding path 3 of a workpiece 4 before performing a welding process. The welding device 1 is used to carry out a welding process on a workpiece 4 with fixed welding parameters Pᵢ(x) as a function of the position x along the welding path 3. To that end, a welding torch 2 is fastened to a robot 11 which guides the welding torch 2 over the workpiece 4 along a predetermined welding path 3 during the welding process and produces a welded joint between two or more workpieces 4 or a coating of a workpiece 4. The welding torch 2 is connected to the welding power source 12 whose control device 13 controls or regulates the welding process and the corresponding fixed welding parameters Pᵢ(x). During the processing, the workpiece 4 is held in the desired position by means of clamping devices 17. The arrangement and geometry of the clamping devices 17, the geometry of the workpiece 4 and a number of other factors, such as, for example, the temperature of the workpiece 4, influence the cooling behaviour of the weld seam and thus the quality of the welded joint. Usually, certain welding parameters Pᵢ(x) for the welding process are determined on the basis of experience or previous test welds on test workpieces and the welding process is carried out independently of the respective cooling situation.

According to the invention, it is now provided that before the welding process is carried out, at least one parameter P_{K}(x) representing the cooling is recorded depending on the position (x) along the welding path 3, and the at least one parameter P_{K}(x) representing the cooling along the welding path 3 is considered for the welding process during the definition of optimised welding parameters P_{i,opt}(x) depending on the position x along the welding path (3). For this purpose, a recording device 15 is located on the robot 11, which heats the workpiece 4 before the welding process and detects the cooling behaviour and derives or calculates therefrom at least one parameter P_{K}(x) representing the cooling. The cooling behaviour of the workpiece 4 is thus analysed under the real conditions, considering the geometry and arrangements of the clamping devices 17 and taking into consideration the geometry of the workpiece 4 and considering the environmental conditions, in order to be able to incorporate the respective cooling behaviour into the definition of the optimised welding parameters P_{i,opt}(x). The parameters P_{K}(x), which are representative of the cooling, can be considered in the definition of the optimised welding parameters P_{i,opt}(x) for an optimum welding result and maximum welding quality. For example, it is possible to proceed at locations along the welding path 3 of the workpiece 4 with good or rapid cooling behaviour with a lower welding speed or higher welding power than at locations with slower cooling behaviour. The welding quality can also be improved by preheating the workpiece 4 at certain points, taking into account the cooling behaviour of the workpiece 4 at these points.

During the recording of the parameters P_{K}(x) representing the cooling, the robot 11 travels with the recording device 15 along the desired welding path 3 and heats the workpiece 4 to a temperature which is preferably below the melting temperature of the material of the workpiece 4 and also below that temperature which could lead to a structural change in the material of the workpiece 4. Following the heating, the surface temperature of the workpiece 4 is detected and evaluated and at least one parameter P_{K}(x) representing the cooling, for example the cooling rate ΔT/Δt, is calculated therefrom. The parameters P_{K}(x) representing the cooling are stored in a database 18 or a memory. Thus, in the subsequent welding process, a correction can be made by means of the optimised welding parameters P_{i,opt}(x), considering the cooling behaviour of the real workpiece 4. The memory 18 can be located at different points of the welding system and can, for example, also be integrated into the welding current source 12.

The process of recording the at least one parameter P_{K}(x) representing the cooling along the welding path 3 can be carried out at a speed v_{A} which is higher than or equal to the welding speed vₛ during the welding process. In order to save time, the at least one parameter P_{K}(x) representing the cooling along the welding path 3 can also be recorded directly preceding the welding process or during a cleaning process to be carried out before the welding process.

FIG. 2 shows a block diagram of an embodiment of a recording device 15 for recording a parameter P_{K}(x) representing the cooling along the welding path 3 of a workpiece 4. The recording device 15 contains a heat source 5 with which the workpiece 4 is heated to a temperature which is below the melting temperature of the material of the workpiece 4 and below the temperature at which the structure of the workpiece 4 is changed. The heating of the workpiece 4 along the welding path 3 can take place, for example, in the form of pulses. The heat source 5 may be generated by a light source 7, in particular a laser beam source 8. The at least one parameter P_{K}(x) representing the cooling along the welding path 3 is recorded in a contactless manner with the aid of at least one detection device 6, which can be formed by a thermal imaging camera 9, in particular an infrared camera. Instead of or in addition to a thermal imaging camera 9, at least one temperature sensor 10 or an array of a plurality of temperature sensors 10 can also be used for detecting the temperature on the surface of the workpiece 4. In addition to recording the at least one parameter P_{K}(x) representing the cooling along the welding path 3, and in particular during this recording, the basic workpiece temperature Tu can also be recorded with the aid of at least one temperature sensor 14.

If a parameter P_{K}(x) representing the cooling exceeds certain threshold values P_{KG}(x), a warning (for example in acoustic or visual form) could be issued to alert the user to an impermissible or critical cooling situation. The user can then carry out appropriate countermeasures, such as, for example, a displacement of clamping devices or a preheating or cooling of the workpiece 4, in order to again observe the threshold values P_{KG}(x). In addition to the warning or as an alternative thereto, a corresponding message can also be stored for documentation purposes.

In FIG. 3, a schematic block diagram of a virtual recording device 15′ for recording at least one parameter P_{K}(x) representing the cooling along the virtual welding path 3′ of a virtual workpiece 4′ is represented. In this case, the virtual workpiece 4′, together with the virtual clamping devices 17′, is simulated on a computer 16 or a mobile terminal, such as, for example, a smartphone, and, before the welding process is carried out, the virtual replication 4′ of the workpiece 4 is heated along a virtual welding path 3′, corresponding to the welding path 3, with a virtual heat source 5′ or the virtual welding process itself, and the at least one parameter P_{K}(x) representing the cooling is recorded or calculated or simulated along the virtual welding path 3′ with the aid of at least one virtual detection device 6′. The parameters P_{K}(x) representing the cooling are stored in a database 18 or a memory. The software required for this purpose makes use of stored information on the heat-conducting properties of various materials for the workpieces 4 and clamping devices 17, which have been determined beforehand. By means of such a simulation, various situations can be tried out before the welding process is carried out without needing to use a real workpiece 4. In this way, welding parameters P_{i,opt}(x) optimised in a simple and rapid manner can be adapted as a function of the respective prevailing cooling situation of the workpiece 4 in order to achieve the best welding qualities in each case.

In FIG. 4 a schematic representation of a welding device 1 during the execution of a welding process, considering at least one parameter P_{K}(x) recorded before the welding process and representing the cooling in the determination of optimised welding parameters P_{i,opt}(x) is represented. In this case, the parameters P_{K}(x) determined before the welding process is carried out and stored in a database 18 or the like are taken into account as a function of the point along the welding path 3 for correcting or changing the fixed welding parameters Pᵢ(x), and optimised welding parameters P_{i,opt}(x) are thus determined with which the welding process is carried out. As a result, an optimum quality of the weld seam along the welding path 3 of the workpiece 4 is achieved, taking into account the cooling behaviour of the workpiece. In addition, external measures, such as, for example, the preheating of the workpiece, can influence the cooling behaviour of the workpiece 4 and a higher welding quality can be achieved.

FIGS. 5A to 5C represent various clamping situations of a workpiece 4 for illustrating the resulting different cooling behaviour along the welding path 3. In the side view of a workpiece 4 according to FIG. 5A, the clamping devices are arranged very close to the welding path 3. This results in maximum cooling. In the variant according to FIG. 5B, the clamping devices are arranged at a greater distance from the welding path, as a result of which normal cooling of the weld seam results. In the variant according to FIG. 5C, the clamping devices 17 are arranged very far away from the welding path 3 and cover only a very short region of the workpiece 4. In this variant, a minimal cooling effect results due to the clamping devices. These illustrations illustrate the influence of the geometry and arrangement of the clamping devices 17 on the cooling behaviour of the workpiece 4 after a welding process. The cooling situation of a workpiece can thus also be influenced by a corresponding arrangement of the clamping devices 17. In addition to the arrangement of the clamping devices 17, the cooling effect is also dependent on the material of the clamping devices 17 and their thermal conductivity, as well as on the contact surface between the workpiece 4 and the clamping device 17.

FIGS. 6A and 6B show time cooling curves with different cooling behaviours and different temperatures T of the workpiece 4. FIG. 6A shows the time cooling curve of a workpiece 4 without prior heating (Curve A) and with prior heating (Curve B). FIG. 6B shows the time cooling of a workpiece 4 with normal cooling (Curve A) and strong cooling (Curve B).

In FIG. 7, the course over time of a method carried out before the welding process for registering at least one parameter P_{K}(x) representing the cooling along the welding path 3 of a workpiece 4 and the subsequent welding process, considering the at least one parameter P_{K}(x) representing the cooling, is shown in the definition of the optimised welding parameters P_{i,opt}(x). As already mentioned above, the Phase I of the recording of the parameters P_{K}(x) representing the cooling of the workpiece 4 can also take place at a higher speed v_{A} than the subsequent welding process (Phase II), which takes place at a lower speed vₛ.

1. A method for defining welding parameters (Pᵢ(x)) for a welding process on a workpiece (4), in which a welding torch (2) fastened to a robot (11) is guided over the workpiece (4) along a predetermined welding path (3) and predetermined welding parameters (Pᵢ(x)) for processing the workpiece (4) are set as a function of the position (x) along the welding path (3), wherein, before the welding process is carried out, at least one parameter (P_{K}(x)) representing the cooling is recorded as a function of the position (x) along the welding path (3), and the at least one parameter (P_{K}(x)) representing the cooling along the welding path (3) is considered for the welding process when defining optimized welding parameters (P_{i,opt}(x)) as a function of the position (x) along the welding path (3).

2. The method according to claim 1, wherein, before the welding process is carried out, the workpiece (4) is heated along the welding path (3) with a heat source (5), and the at least one parameter (P_{K}(x)) representing the cooling is recorded along the welding path (3) with the aid of at least one detection device (6).

3. The method according to claim 2, wherein the workpiece (4) is heated in a pulsed manner along the welding path (3), preferably to a temperature below the melting temperature (Tₛ) of the workpiece (4).

4. The method according to claim 2, wherein, in addition to, in particular during, the recording of the at least one parameter (P_{K}(x)) representing the cooling along the welding path (3), the workpiece base temperature (Tᵤ) is recorded.

5. The method according to claim 2, wherein the at least one parameter (P_{K}(x)) representing the cooling is recorded along the welding path (3) during a cleaning process carried out before the welding process, in particular a surface plasma processing operation.

6. The method according to claim 1, wherein, prior to carrying out the welding process, a virtual replication (4′) of the workpiece (4) is heated along a virtual welding path (3′) corresponding to the welding path (3) with a virtual heat source (5′), and the at least one parameter (P_{K}(x′)) representing the cooling is recorded along the virtual welding path (3′) with the aid of at least one virtual detection device (6′).

7. The method according to claim 1, wherein, before the welding process is carried out, the at least one parameter (P_{K}(x′)) representing the cooling along a virtual welding path (3′) corresponding to the welding path (3) is determined from stored properties of the virtual replication (4′) of the workpiece (4) in dependence on the material and the geometric conditions from a virtual replication (4′) of the workpiece (4) with predetermined environmental situations, for example clamping devices (17).

8. The method according to claim 1, wherein the process of recording the at least one parameter (P_{K}(x)) representing the cooling along the welding path (3) is carried out at a speed (v_{A}) which is higher than or equal to the welding speed (vₛ) during the welding process.

9. The method according to claim 1, wherein the average cooling rate (ΔT/Δt) is recorded as a parameter (P_{K}(x)) representing the cooling.

10. The method according to claim 1, wherein, when exceeding and/or falling below predetermined threshold values (P_{KG}(x)) for the parameter (P_{K}(x)) representing the cooling along the welding path (3), a warning is issued and/or a message is stored.

11. A welding device (1) for carrying out a welding process on a workpiece (4) with fixed welding parameters (Pᵢ(x)), having a welding torch (2) which is fastened to a robot (11) and is guidable over the workpiece (4) along a predetermined welding path (3) during the welding process, wherein the welding torch (2) is connected to a welding current source (12), which welding current source (12) has a control device (13) for controlling the welding process with predetermined welding parameters (Pᵢ(x)) as a function of the position (x) along the welding path (3), wherein a recording device (15) is provided for recording at least one parameter (P_{K}(x)) representing the cooling as a function of the position (x) along the welding path (3) before carrying out the welding process, and wherein the control device (13) is connected to the recording device (15) and configured for controlling the welding process with optimized welding parameters (P_{i,opt}(x)) as a function of the position (x) along the welding path (3), taking into account the at least one parameter (P_{K}(x)) representing the cooling along the welding path (3).

12. The welding device (1) according to claim 11, wherein the recording device (15) for recording the at least one parameter (P_{K}(x)) representing the cooling along the welding path (3) contains a heat source (5) for heating the workpiece (4) along the welding path (3) and at least one detection device (6) for recording the at least one parameter (P_{K}(x)) representing the cooling along the welding path (3).

13. The welding device (1) according to claim 12, wherein the heat source (5) for heating the workpiece (4) along the welding path (3) is generated by a light source (7), in particular a laser beam source (8).

14. The welding device (1) according to claim 12, wherein at least one detection device (6) is formed by a thermal imaging camera (9), in particular an infrared camera, and/or by at least one temperature sensor (10) for measuring the temperature of the surface of the workpiece (4) along the welding track (3).

15. The welding device (1) according to claim 11, wherein the recording device (15) for recording the at least one parameter (P_{K}(x)) representing the cooling along the welding path (3) contains a virtual heat source (5′) for heating a replication (4′) of the workpiece (4) along a corresponding virtual welding path (3′) of the welding path (3) and at least one virtual detection device (6′) for recording the at least one parameter (P_{K}(x′)) representing the cooling along the virtual welding path (3′).
